(19) United States
(12) Patent Application Publication
(10) Pub. No.: US 2020/0064830 A1
(43) Pub. Date: Feb. 27, 2020

(54) UNMANNED MOVING BODY AND UNMANNED MOVING BODY SYSTEM USING THE SAME

(71) Applicant: PRODRONE CO., LTD., Nagoya-shi, Aichi (JP)

(72) Inventor: Kazuo ICHIHARA, Nagoya-shi (JP)

(73) Assignee: PRODRONE CO., LTD., Nagoya-shi, Aichi (JP)

(21) Appl. No.: 16/607,198

(22) PCT Filed: Aug. 29, 2018
(86) PCT No.: PCT/JP2018/031855

§ 371 Date: Oct. 22, 2019

(30) Foreign Application Priority Data
Aug. 30, 2017 (JP) 2017-165344

(51) Int. Cl. G05D 1/00; H04W 4/40; G05D 1/10; B64C 39/02

(52) U.S. Cl. CPC G05D 1/0022; H04W 4/40; G05D 1/0088; B64D 47/08; B64C 39/024; B64C 2201/146; G05D 1/101

(57) ABSTRACT

An unmanned moving body includes: a receiver configured to receive a wireless signal; a controller configured to process the wireless signal that has been received; and a position information obtainer configured to detect a current position of the unmanned moving body. The wireless signal includes target area information indicating a position range. The controller is configured to determine whether to accept or disregard the wireless signal based on the position of the unmanned moving body and the target area information. The above object is also solved by an unmanned moving body system that includes: the unmanned moving body according to the present invention; and a transmitter configured to transmit the wireless signal simultaneously to a plurality of the unmanned moving bodies.

### TECHNICAL FIELD

The present invention relates to a technique of controlling an unmanned moving body.

### BACKGROUND ART

Patent literature 1 discloses a collision avoidance system that broadcasts, to aerial vehicles flying in formation, position information on positions of the aerial vehicles.

### CITATION LIST

### Cited Literature

PTL1: JP-T-2002-534690

### SUMMARY OF INVENTION

### Technical Problem

In dynamic control of motions of a large number of unmanned moving bodies, it is not efficient to sequentially transmit control signals to individual unmanned moving bodies. In contrast, in collective control of all these unmanned moving bodies using a single control signal, the control is limited to a motion that all unmanned moving bodies within a zone are able to perform.

In light of the above-described problems, a problem to be solved by the present invention is to provide: an unmanned moving body capable of controlling a plurality of airframes efficiently and flexibly; and an unmanned moving body system using the unmanned moving body.

### Solution to Problem

In order to solve the above-described problem, an unmanned moving body according to the present invention includes: a receiver configured to receive a wireless signal; a controller configured to process the wireless signal that has been received; and a position information obtainer configured to detect a current position of the unmanned moving body. The wireless signal includes target area information indicating a position range. The controller is configured to determine whether to accept or disregard the wireless signal based on the position of the unmanned moving body and the target area information.

Thus, target area information is contained in a wireless signal, and the unmanned moving body compares the position of the unmanned moving body with the target area information to determine whether to accept or disregard the wireless signal. This ensures that control with the position of the unmanned moving body used as a reference is performed.

The unmanned moving body according to the present invention may further include a storage device in which a plurality of zones defined on a surface or in a space in which the unmanned moving body moves are registered and correlated with block IDs that are information for identifying the respective zones. The target area information may be the block ID or block IDs. The controller may be configured to determine whether to accept or disregard the wireless signal based on one block ID of the block IDs that corresponds to one zone of the zones in which the unmanned moving body exists and based on the target area information.

For example, longitude and latitude values indicating a geographical range maybe used as the target area information in the wireless signal, and the unmanned moving body may arbitrarily check whether the current location of the unmanned moving body is included within the range. In this case, due to the load of the operation involved in the checking processing, the unmanned moving body may delay in making a reaction and/or the controller may encounter a hang-up. In light of the considerations above, the movement surface or the movement space of the unmanned moving body is divided into a plurality of zones, and the unmanned moving body determines whether to accept or disregard the wireless signal using block IDs of the zones. This simplifies the processing of checking the target area information, reducing the load of the checking processing.

Preferably, the unmanned moving body according to the present invention is an unmanned rotary-wing aerial vehicle.

Small-size unmanned aerial vehicles represented by industrial unmanned helicopters have had airframes too expensive to be affordable. Also, these vehicles used to require skillful pilotage for stable flight. In recent years, however, there have been improvements and cost reductions in sensors and software used to control posture of unmanned aerial vehicles and to implement autonomous flight of unmanned aerial vehicles. This has led to considerable improvement in manipulability of unmanned aerial vehicles. In particular, small size multi-copters are simpler in rotor structure than helicopters and thus easier to design and maintain. As such, small size multi-copters are not only used for hobbyist purposes but also applied to various missions in a wide range of fields. Applying the present invention to such unmanned aerial vehicles further widens the applicability of unmanned aerial vehicles.

In order to solve the above-described problem, an unmanned moving body system according to present invention includes: the receiver and the controller according to the present invention; and a transmitter configured to transmit the wireless signal simultaneously to a plurality of the receivers.

In the unmanned moving body system according to the present invention, the transmitter transmits a wireless signal over a wide range. When a plurality of unmanned moving bodies (receivers and controllers) have received the wireless signal, each unmanned moving body compares the position of its airframe with the target area information to determine whether to accept or disregard the wireless signal. By widening the position range included in the target area information, the transmitter is able to collectively control a large number of unmanned moving bodies. By narrowing the position range, the transmitter is able to control a particular unmanned moving body alone. This ensures that a large number of unmanned aerial vehicles is controlled flexibly.

The unmanned moving body system according to the present invention may further include a management device to which a plurality of the transmitters are connected. Each transmitter of the plurality of the transmitters may have a jurisdiction range that is a position range of which the each transmitter is in charge.

Thus, the plurality of transmitters each in charge of a jurisdiction range are connected to the management device, which is a device upper in level than the transmitters, so that the transmitters are operated by the management device. This ensures that unmanned moving bodies are controlled over a wider position range.

### Advantageous Effects of Invention

Thus, the unmanned moving body according to the present invention and the unmanned moving body system using the unmanned moving body according to the present invention ensure that a plurality of unmanned moving bodies are controlled efficiently and flexibly.

### BRIEF DESCRIPTION OF DRAWINGS

FIG. 1 is a schematic outlining an unmanned moving body system according to a first embodiment.

FIG. 2 is a block diagram illustrating a functional configuration of a multi-copter according to the first embodiment.

FIG. 3 is a block diagram illustrating a functional configuration of a transmitter.

FIG. 4 is a block diagram illustrating a functional configuration of a management device.

FIG. 5 is a schematic outlining an unmanned moving body system according to a second embodiment.

FIG. 6 is a schematic illustrating an example in which a flight space of the multi-copters is divided not only in a horizontal direction but also in a height direction.

FIG. 7 is a block diagram illustrating a functional configuration of a multi-copter according to the second embodiment.

### DESCRIPTION OF EMBODIMENTS

Embodiments of the present invention will be described below. The embodiments described below are example unmanned moving body systems capable of controlling, using a single transmitter, a plurality of unmanned rotary-wing aerial vehicles, which are unmanned moving bodies. It is to be noted that the unmanned moving body according to the present invention will not be limited to unmanned rotary-wing aerial vehicles. Other examples include unmanned fixed wing aerial vehicles, unmanned vehicles that travel on the ground or a floor surface, and even unmanned watercrafts. Also, there is no limitation to how large or small the airframe is. Also, the transmitter may not necessarily be implemented by a single transmitter but may be implemented by a plurality of transmitters, in which case processing can be divided and assigned to the plurality of transmitters.

### First Embodiment

### (Configuration Outline)

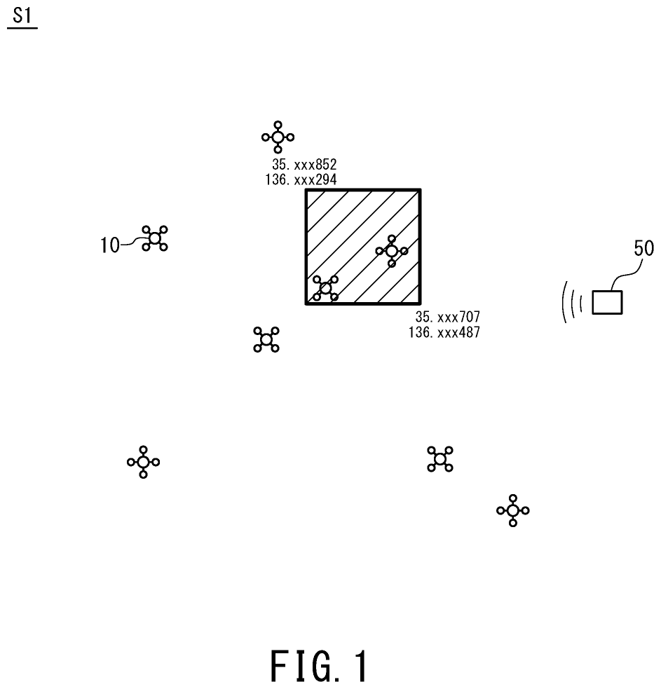

FIG. 1 is a schematic outlining an unmanned moving body system S1 of this example. The unmanned moving body system S1 includes: a plurality of multi-copters 10, which are unmanned rotary-wing aerial vehicles; and a single transmitter 50. The transmitter 50 transmits the same wireless signal simultaneously to all plurality of multi-copters 10 located within the radio wave zone of the transmitter 50.

The wireless signal transmitted by the transmitter 50 of this example is a control signal for controlling flight motions of the multi-copters 10. The control signal includes target area information, which is information indicating a position range. Each of the multi-copters 10 receives the control signal from the transmitter 50, and compares the position of the airframe of the multi-copter 10 with the target area information to determine whether to accept or disregard the control signal. As used herein, the term “position range” refers to a predetermined range on a horizontal surface, a predetermined range in a vertical direction, or a combination of these ranges. Also, the position range is intended to include not only a continuous range but also a plurality of separate ranges.

The control signal transmitted by the transmitter 50 of this example includes a geographical range as target area information. The geographical range is represented by longitude and latitude values (in FIG. 1, the range is defined by a latitude range of 35.xxx707 to 852 and a longitude range of 136.xxx294 to 487). Each multi-copter 10 checks whether the longitude and latitude of the airframe of the multi-copter 10 is included in the position range included in the target area information. When the longitude and latitude is included in the position range, the multi-copter 10 accepts the control signal. When the longitude and latitude is not included in the position range, the multi-copter 10 disregards the control signal. By widening the position range included in the target area information, the transmitter 50 is able to collectively control a large number of multi-copters 10. By narrowing the position range, the transmitter 50 is able to control a particular multi-copter 10 alone. This enables the unmanned moving body system S1 to flexibly control a large number of multi-copters 10 based on the positions of the individual multi-copters 10.

While the target area information of this example is represented by a rectangular position range defined by longitude and latitude values of the northwest end of the rectangle and longitude and latitude values of the southeast end of the rectangle, the target area information may be represented otherwise. Another possible example is a circular position range defined by a combination of longitude and latitude values of the center of the position range and the radius and the diameter [m] of the circle. Still another possible example is a polygonal position range defined by three or more pairs of longitude and latitude values that are arranged in the target area information and that are connected to each other by lines in clockwise and counter-clockwise directions.

### (Multi-Copter Configuration)

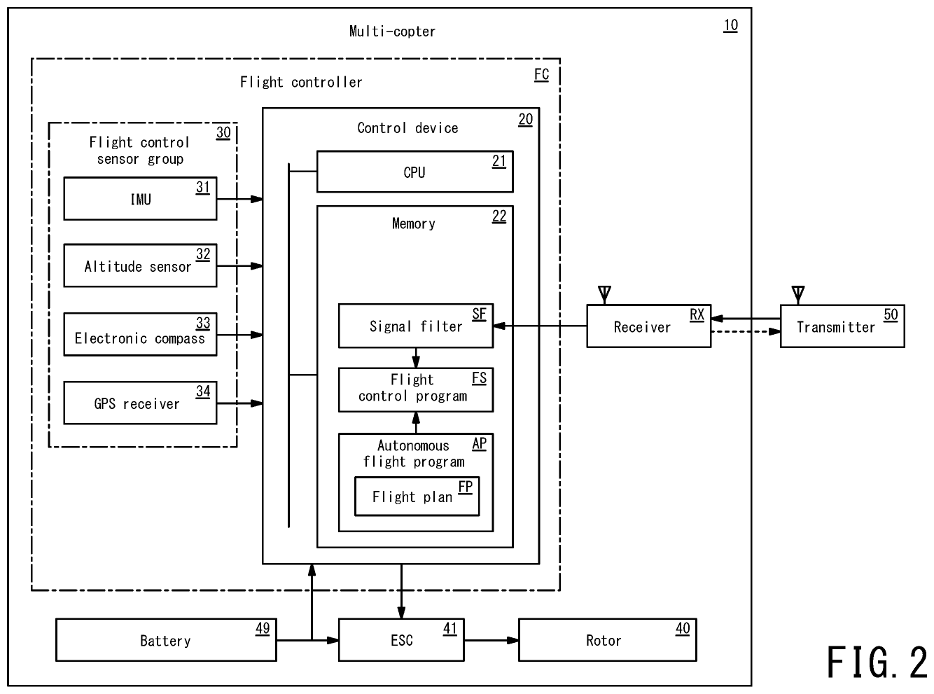

FIG. 2 is a block diagram illustrating a functional configuration of each multi-copter 10. The multi-copter 10 of this example mainly includes: a flight controller FC, which controls flight motions of the multi-copters 10; rotors 40, which are brushless motors on which a plurality of propellers are mounted; an ESC (Electric Speed Controller), which is a driving circuit for the rotor 40; a receiver RX, which receives the control signal from the transmitter 50; and a battery 49, which supplies power to the foregoing elements.

The flight controller FC includes a control device 20, which is a controller. The control device 20 includes: a CPU 21, which is a central processing unit; a memory 22, which is a storage device such as ROM, RAM, and flash memory; and a PWM (Pulse Width Modulation) controller (not illustrated), which controls the number of rotations of the rotors 40 via the ESC 41.

The flight controller FC further includes a flight control sensor group 30, which includes an IMU (Inertial Measurement Unit), an altitude sensor 32, an electronic compass 33, and a GPS receiver 34. These elements are connected to the control device 20.

The IMU 31 mainly includes a three-axis acceleration sensor and a three-axis angular velocity sensor, and serves as a sensor to detect the inclination of the airframe of the multi-copter 10. A pneumatic sensor is used as the altitude sensor 32 of this example. The altitude sensor 32 calculates, based on an air pressure altitude that has been detected, the sea level altitude (height) of the multi-copter 10. A three-axis geomagnetic sensor is used as the electronic compass 33 of this example. The electronic compass 33 detects the azimuth angle of the airframe nose of the multi-copter 10. The GPS receiver 34 is, in a strict sense, a receiver in Navigation Satellite System (NSS). The GPS receiver 34 obtains information on present longitude and latitude values and present time from Global Navigation Satellite System (GNSS) or Regional Navigation Satellite System (RNSS). The GPS receiver 34 is the position information obtainer of this example. The flight controller FC obtains, using the flight control sensor group 30, position information indicating the position of the airframe including: the inclination of the airframe; the rotation of the airframe; the longitude and latitude of the airframe in flight; the altitude of the airframe in flight; and the azimuth angle of the airframe nose in flight.

While the multi-copters 10 of this example are intended for outdoor use, the unmanned moving body system according to the present invention also finds applications in unmanned moving bodies intended for indoor movement. For example, it is possible to: arrange beacons to receive wireless signals at predetermined intervals in a facility; and, based on the field strengths of the signals received from these beacons, measure relative distances between an unmanned moving body and the beacons, thereby identifying the position of the unmanned moving body in the facility. For further example, it is possible to: provide the unmanned moving body with a camera; perform image recognition of a moving image of the surroundings of the unmanned moving body taken by the camera, thereby detecting a characteristic position in a facility; and based on the characteristic position, identify the position of the unmanned moving body in the facility. Similarly, it is possible to: provide the unmanned moving body with a distance measuring sensor utilizing laser, infrared light, or ultrasonic; and measure the distance between the unmanned moving body and a floor surface (or a ceiling surface) or a wall surface in a facility, thereby identifying the position of the unmanned moving body in the facility. In these cases, the position information obtainer according to the present invention corresponds to the means for communication with the beacons, the means for measuring relative distances with these beacons, the camera, and/or the distance measuring sensor.

The control device 20 includes a flight control program FC, which is a program for controlling the posture of the multi-copter 10 during flight and controlling basic flight operations. The flight control program FC adjusts the number of rotations of the individual rotors 40 based on information obtained from the flight control sensor group 30, and causes the multi-copter 10 to fly while correcting the posture and/or position of the airframe of the multi-copter 10.

The control device 20 also includes an autonomous flight program AP, which is a program for causing the multi-copter 10 to fly autonomously. In the memory 22 of the control device 20, a flight plan FP is registered. The flight plan FP is parameter data such as: longitude and latitude of the destination and/or a transit point of the multi -copter 10; and altitude and/or speed of the multi-copter 10 in flight. The autonomous flight program AP causes the multi-copter 10 to fly autonomously based on the flight plan FP, under the starting condition that an instruction has been transmitted from the transmitter 50 or time has passed to reach a predetermined point of time. In this example, this autonomous flight function will be referred to as “autopilot”.

The multi-copters 10 of this example are basically intended for autopilot flight, and the control signal of this example is a signal for updating the flight plan FP of each multi-copter 10. Additionally, routine motions are incorporated in the autonomous flight program AP of this example. The routine motions are particular flight motions defined in advance, such as a take-off to a predetermined altitude, a wait (hovering), a landing, a returning movement to a take-off point, and a linear movement to a specified position. One kind of the control signal of this example includes an instruction(s) for performing the routine motions. Otherwise, with the transmitter 50 of this example, the multi-copters 10 can be manually operated successively with the support of autopilot (such as automatic maintenance of airframe's nose direction, longitude and latitude, and altitude).

The control device 20 also includes a signal filter SF, which is a program for determining whether to accept or disregard the control signal. The signal filter SF compares the target area information in the control signal received by the receiver RX with the longitude and latitude of the airframe of the multi-copter 10 obtained at the GPS receiver 34. When the longitude and latitude of the airframe of the multi-copter 10 is included in the position range included in the target area information, the signal filter SF accepts the control signal. When the longitude and latitude of the airframe of the multi-copter 10 is not included in the position range, the signal filter SF disregards the control signal. While the signal filter SF of this example is included in the control device 20, which is a device separate from the receiver RX, the receiver RX includes the signal filter SF. Providing the signal filter SF in the receiver RX not only reduces the load of the operation performed by the control device 20 but also ensures that a typical flight controller product can be used as the flight controller FC of the multi-copter 10.

### (Transmitter Configuration)

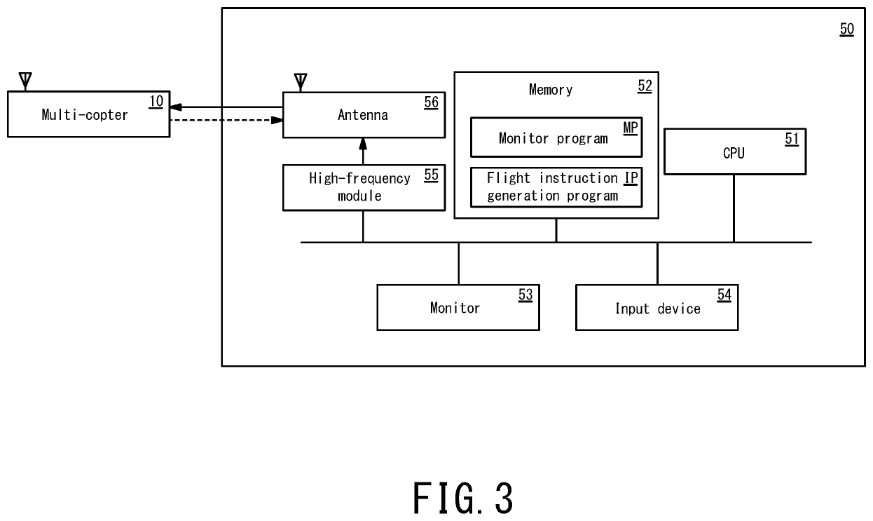

FIG. 3 is a block diagram illustrating a functional configuration of the transmitter 50. The transmitter 50 of this example mainly includes: a CPU 51, which is a central processing unit; a memory 52, which is a storage device such as RAM and ROM; an input device 54, which is an interface to receive an input from an operator; a monitor 53, which displays a flight situation in which each multi-copter 10 is flying; and an antenna 56 and a high-frequency module 55, which transmit the control signal for the multi-copter 10.

The transmitter 50 of this example includes a monitor program MP and a flight instruction generation program IP. The monitor program MP obtains, from each multi-copter 10, telemetry data (see broken-line arrows in FIGS. 1 and 3); maps airframe information on map data, examples of the airframe information including the flight position of the multi-copter 10 and the amount of residual battery; and displays the airframe information on the monitor 53. While checking the monitor 53, the operator uses the flight instruction generation program IP to set an instruction transmitted to the multi-copter 10 and the position range. It is to be noted that the receiving of the telemetry data from the multi-copter 10 and/or the mapping on map data may be omitted. Even though the position of each multi-copter 10 is not displayed on the monitor 53 (map data), the multi-copter 10 accepts the control signal if the multi-copter 10 is flying in the position range specified by the operator.

It is to be noted that there is no limitation to the method of communication between the transmitter and the unmanned moving body (receiver) according to the present invention, insofar as: a wireless signal receivable by a plurality of unmanned moving bodies is transmitted simultaneously to the plurality of unmanned moving bodies; and the target area information can be contained in the wireless signal. Examples include: communication by wireless LAN (IEEE 802.11 standard); and communication using a mobile communication network such as 3G, LTE (Long Term Evolution), and WiMAX (Worldwide Interoperability for Microwave Access). Other examples include communication by pulse modulation such as 2.4 GHz PPM (Pulse Position Modulation) and PCM (Pulse Code Modulation). It is also possible to make up a unique communication method by which the target area information can be set directly in a packet header or a frame header of a wireless signal. Also, the unit of signal by which the signal filter SF determines whether to accept or disregard a wireless signal may be packet or data frame, or a piece of information (application level information) that makes a meaning. It is to be noted that the signal filter SF of this example is intended to determine whether to accept or disregard a wireless signal based on the latter unit.

Also, as described earlier, the number of transmitters 50 used in the unmanned moving body system S1 will not be limited to one; it is possible to use a plurality of transmitters 50. In this case, each transmitter 50 of the transmitters 50 may be in charge of a jurisdiction range, which is the position range that the each transmitter 50 is in charge of, and these transmitters 50 may be connected to a management device 60, which is a device upper in level than the transmitters 50.

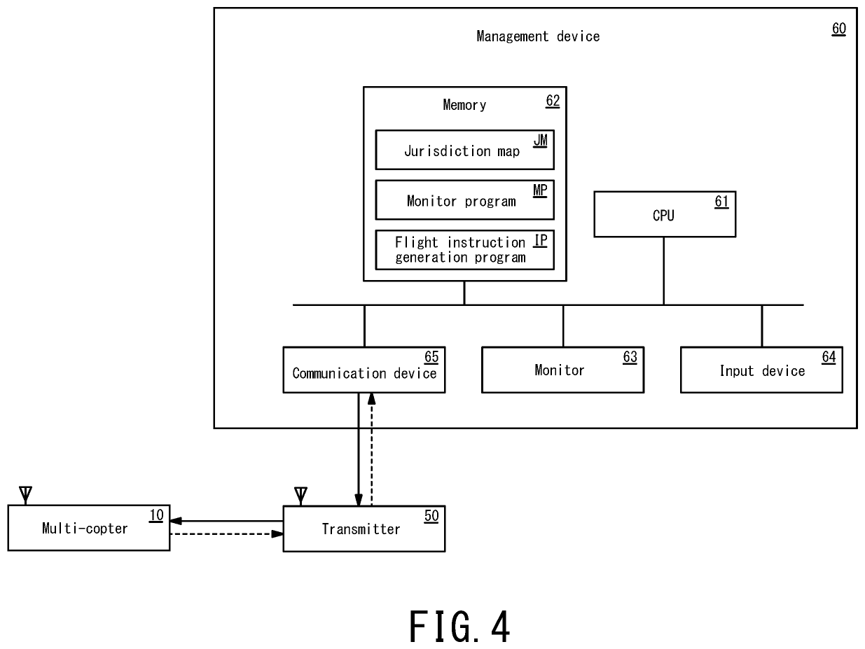

FIG. 4 is a block diagram illustrating a functional configuration of the management device 60. The management device 60 of this example includes: a CPU 61, which is a central processing unit; a memory 62, which is a storage device such as RAM and ROM; an input device 64, which is an interface to receive an input from the operator; and a monitor 63, which displays the flight situation in which each multi-copter 10 is flying. Examples of the management device 60 include a typical laptop personal computer and a tablet computer.

Similarly to the transmitter 50, the management device 60 of this example includes a monitor program MP and a flight instruction generation program IP. The monitor program MP obtains, from each multi-copter 10, telemetry data (see broken-line arrows in FIG. 4); maps airframe information on map data, examples of the airframe information including the flight position of the multi-copter 10 and the amount of residual battery; and displays the airframe information on the monitor 63. While checking the monitor 63, the operator uses the flight instruction generation program IP to set a control signal transmitted to the multi-copter 10 and the position range. Then, the operator transmits the control signal to the multi-copter 10 through the transmitter 50. It is to be noted that when the management device 60 of this example is provided, the user interface for the transmitter 50 (the input device 54 and the monitor 53), the monitor program MP, and/or the flight instruction generation program IP may be omitted. Otherwise, the flight instruction generation program IP of the management device 60 may, for example, generate parameters as an original form of the control signal, and transmit the parameters to the transmitter 50. Then, the flight instruction generation program IP of the transmitter 50 may generate the control signal based on the parameters.

The management device 60 of this example further includes a jurisdiction map JM, which is a database in which IDs of the transmitters 50 are registered and correlated with respective jurisdiction ranges. The management device 60 compares the target area information in the control signal with the jurisdiction map JM to identify the transmitter 50 in charge of the position range, and transmits to the transmitter 50 a transmission instruction for the control signal. Otherwise, the management device 60 may, for example, transmit a transmission instruction for the control signal to all the transmitters 50. Then, based on the target area information in the control signal, the transmitters 50 may determine whether it is necessary to transmit the control signal.

### Second Embodiment

A second embodiment of the present invention will be described below. It is to be noted that identical or like elements in this and the previous embodiments will be assigned the same reference numerals and will not be elaborated upon here.

### (Configuration Outline)

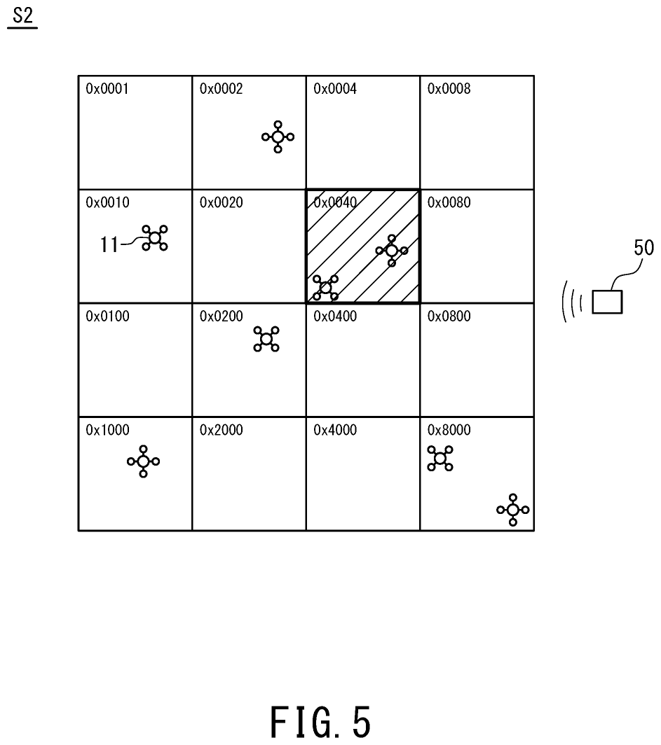

FIG. 5 is a schematic outlining an unmanned moving body system S2 of this example. The unmanned moving body system S2 includes a plurality of multi-copters 11 and a single transmitter 50. The wireless signal transmitted by the transmitter 50 of this example is a control signal to control flight motions of the multi-copters 11, similarly to the wireless signal in the first embodiment.

In this example, the flight space of the multi-copters 11 is divided into a plurality of zones defined by longitude and latitude. These zones are assigned respective block IDs (0x0001 to 0x8000), which are information to identify the individual zones. A block ID is used as the target area information included in the control signal of this example, and each multi-copter 11 determines whether to accept or disregard the control signal based on the block ID included in the control signal and the block ID of the zone in which the airframe of the multi-copter 11 exists. While in this example the flight space is divided into a total of 16 zones, this example may be used in such an application in which there is only one zone that is assigned a block ID. In this case, it can be assumed that there are two zones (a plurality of zones), the zone with the block ID and a zone without block ID.

In the example illustrated in FIG. 5, the target area information in the transmitted control signal is specified as 0x0040, so that the control signal is accepted only by a multi-copter(s) 11 flying in the zone with the block ID 0x0040. In this respect, each zone of this example is assigned a 2-byte hexadecimal number as the block ID. The block IDs of this example are assigned such that the sum of any combination of the blocks ID is a unique value. That is, any combination of the zones can be represented by a 2-byte value.

More specifically, a bit digit of each block ID of this example is correlated with anyone of the zones, and one zone or a plurality of zones can be represented by simply turning the bit digits on and off. For example, the block ID 0x0040 can be represented as 0000000001000000 in binary number. That is, the seventh bit from the lowermost-level bit is used only for this zone. When this bit is on in the block ID included in the target area information, this means that this zone is included in the position range of the control signal. When this bit is off in the block ID included in the target area information, this means that this zone is not included in the position range of the control signal. Similarly, the block ID 0x0080 can be represented as 0000000010000000 in binary number, and the block ID 0x 2000 can be represented as 0010000000000000 in binary number. For example, when the block ID in the target area information is set at 0010000011000000, that is, 0x20C0, the above-described three zones are intended in the target area information.

Each multi-copter 11 performs AND operation of the block ID of the zone in which the airframe of the multi-copter 11 exists and the block ID in the target area information. When the return value is equal to or more than 1,the multi-copter 11 may accept the target area information. When the return value is 0, the multi-copter 11 may disregard the target area information. This ensures that the complicated work of specifying the position range on the transmitter 50 side is done by one step of processing, and that the accept-disregard determination on the multi-copter 11 side is done by one step of processing. It is to be noted that while the signal filter SF of this example is implemented in the form of a program, the signal filter SF may be implemented in the form of hardware, in which case the above determination is performed at higher speed with reduced load.

It is to be noted that the block IDs of this example will not be limited in form to number. The block IDs according to the present invention may be any other form of information insofar as: each block ID is information from which any one of a plurality of zones on a surface or in a space in which the unmanned moving body moves is identifiable; and the unmanned moving body is able to, based on the block ID, determine whether to accept or disregard a wireless signal.

In the unmanned moving body system S1 according to the first embodiment, the target area information is represented by a geographical range of longitude and latitude values. In this case, when the operation load of the accept-disregard determination on the multi-copter 10 side is at a particular level, the multi-copter 10 may delay in reacting to the control signal or the control device 20 of the multi-copter 10 may encounter a hang-up. In this example, block IDs are used instead of longitude and latitude values. This simplifies the processing of checking the target area information, reducing the operation load on the multi-copter 11 side.

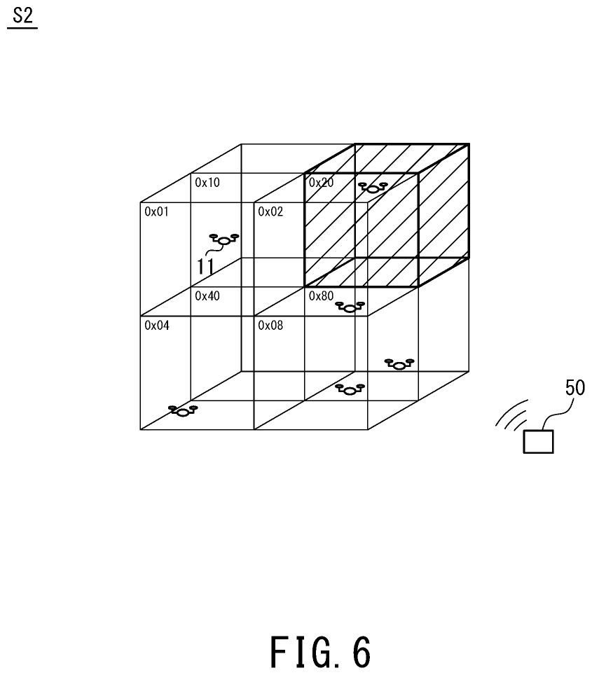

FIG. 6 is a schematic illustrating an example in which the flight space of the multi-copters 11 are divided not only in a horizontal direction but also in a height direction. While the flight space of the above-described example is divided based on longitude and latitude values alone, the flight space may also be divided in the height direction, as illustrated in FIG. 6. This ensures that multi-copters 11 flying in a predetermined altitude range are collectively controlled, with the result that a large number of multi-copters 11 are controlled more flexibly.

### (Multi-Copter Configuration)

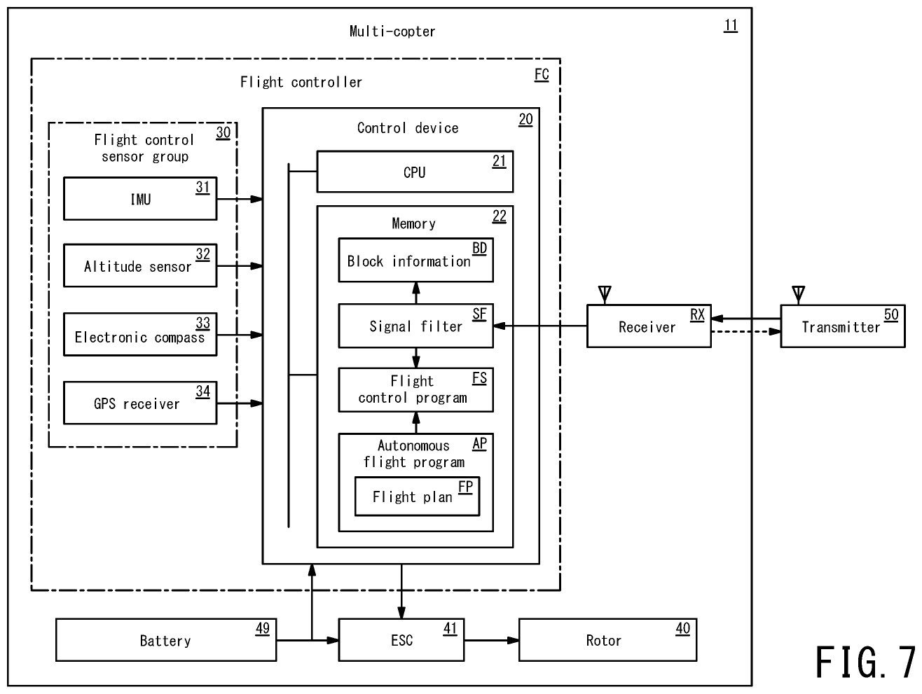

FIG. 7 is a block diagram illustrating a functional configuration of the multi-copter 11. The multi-copter 11 of this example and the multi-copter 10 according to the first embodiment are different from each other in that the multi-copter 11 includes block information BD. The block information BD refers to information in which the longitude-latitude range of each of the zones of space in which the multi-copter 11 flies is correlated with a block ID. Based on the longitude and latitude of the airframe of the multi-copter 11 obtained at the GPS receiver 34, the multi-copter 11 identifies the block ID of the zone in which the airframe of the multi-copter 11 exists, and stores the block ID in a region of the memory 22 accessible at high speed.

While the embodiments of the present invention have been described hereinbefore, the present invention will not be limited in scope to these embodiments, and numerous modifications and variations are possible without departing from the spirit of the invention. For example, while the wireless signals in the above-described embodiments are control signals for the multi-copters 10 and 11, the wireless signals according to the present invention maybe used for a purpose other than controlling unmanned moving bodies. For further example, while each of the multi-copters 10 and 11 of the above-described embodiments determines whether to accept or disregard a control signal based on the current position of the frame of the multi-copter, the determination may be based on a position other than the current position. Other possible examples include: a predicted position equivalent to a few seconds later; the position to which the moving unmanned moving body is directed; and a position that the unmanned moving body passed in the past. Also, while in the above-described embodiments the control signal is accepted when the position of the unmanned moving body is included in the position range included in the target area information, this configuration may be implemented to the contrary; the control signal may be accepted when the position of the unmanned moving body is not included in the position range included in the target area information.

1. An unmanned moving body comprising:
a receiver configured to receive a wireless signal;
a controller configured to process the wireless signal that has been received; and
a position information obtainer configured to detect a current position of the unmanned moving body,
wherein the wireless signal is a control signal for controlling a movement of the unmanned moving body,
wherein the wireless signal comprises target area information indicating a position range, and
wherein the controller is configured to determine whether to accept or disregard the wireless signal based on the position of the unmanned moving body and the target area information.

2. The unmanned moving body according to claim 1, further comprising a storage device in which a plurality of zones defined on a surface or in a space in which the unmanned moving body moves are registered and correlated with block IDs that are information for identifying the respective zones,
wherein the target area information is the block ID or block IDs, and
wherein the controller is configured to determine whether to accept or disregard the wireless signal based on one block ID of the block IDs that corresponds to one zone of the zones in which the unmanned moving body exists and based on the target area information.

3. The unmanned moving body according to claim 1, wherein the unmanned moving body is an unmanned rotary-wing aerial vehicle.

4. An unmanned moving body system comprising:
the receiver and the controller according to claim 1; and
a transmitter configured to transmit the wireless signal simultaneously to a plurality of the receivers.

5. The unmanned moving body system according to claim 4, further comprising a management device to which a plurality of the transmitters are connected,
wherein each transmitter of the plurality of the transmitters has a jurisdiction range that is a position range of which the each transmitter is in charge.
